(19) United States
(12) Patent Application Publication
(10) Pub. No.: US 2005/0228648 A1
(43) Pub. Date: Oct. 13, 2005

(54) Method and device for obtaining parameters for parametric speech coding of frames

(76) Inventor: Ari Heikkinen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/512,099

(22) PCT Filed: Apr. 22, 2002
(86) PCT No.: PCT/IB02/01228

§ 371 Date: May 20, 2005

(51) Int. Cl. G10L 11/04; G10L 19/14

(52) U.S. Cl. 704/205; 704/225

(57) ABSTRACT

The invention provides a novel method for ensuring the phase continuity in transitions from a frame coded by a waveform matching coder to a frame coded using a parametric speech coder in hybrid speech coders. In the proposed method, a phase estimate is derived for the end of the frame modeled by a waveform matching coder. Preferably, the phase estimate is derived from a reconstructed excitation signal of a linear prediction (LP) analysis. For the succeeding frame modeled by a parametric coder, conventional methods are then used for interpolation of the phase characteristic. By using the proposed method, discontinuities due to phase errors are avoided in the reconstructed speech signal. Further, the invention provides a method for detecting misalignments of succeeding coded by waveform matching speech coding and parametric speech coding. Additionally, communication terminals, a network device and a system are introduced which are able to operate the presented methods.

The present invention relates to a method and a device for obtaining at least one phase-characterizing parameter to be used for coding a frame according to a parametric speech coding in accordance with characteristics of a preceding frame coded according to a waveform matching speech coding.

The demand for wireless access to public communication networks is increasing. An important aspect in wireless communication systems, especially cellular mobile communication systems is spectral efficiency, which generally designates the user density for the allocated frequency spectrum. Several factors have to be considered in deternining the system's efficiency; these include cell size, multiple access methods and the modulation technique. However, as speech transmission is likely to be the predominantly used form of communications, the bit rate of the speech coding will play a significant role in determining the system's spectral efficiency.

Therefore, the need for low bit rate speech coding technology (codec and corresponding coder) is of great importance. Of course, the speech coding technology and the related audio coding technology is not limited to communication systems, provided that a wide variety of applications in multimedia applications and storage systems implement speech and audio coding techniques (codes) for analyzing and synthesizing of speech and audio, respectively. The implementation of speech and audio coding techniques within these applications and systems are driven by the needs of saving storage capacity, but also by the needs of transmitting bandwidth equal to the spectral efficiency. Commonly, the quality of the synthesized signals has to be maintained on a high level.

Speech coding technology has advanced significantly during the last two decades and the following description will be dedicated to the speech coding technology. Currently, two prominent speech coder categories exist, especially in view of bit rates around 4 kbits/s (kilobits per second), which is the target bit rate e.g. in the actual ongoing ITU-T standardization process. These categories are often called waveform matching and parametric coders.

In waveform matching coders, as the name implies, the original speech waveform is matched as closely as possible by using appropriate error criteria. The most prominent waveform matching codec is the code excited linear prediction (CELP). Typically, good speech quality has been achieved with waveform coders at bit rates approximately above 5 kbits/s. For example the enhanced full rate speech codec (EFR) according to the IS-641 standard approved in 1996 for the north american TDMA digital cellular system (IS-136) is based on an ACELP (algebraic code excited linear prediction) codec, which is an improved code excited linear prediction (CELP) codec and provides a speech coding at a bit rate of 7.4 kbits/s.

On the other hand, parametric coders, which transmit a description of the essential parameters of the speech signal instead of a description of its waveform, deliver communication-quality speech at low bit-rates and were adopted for several applications. For lower bit rates (in the range of 4 kbits/s) parametric coders are considered to be a more promising approach for achieving good speech quality.

In both coder types, multimodal coding is often used at bit rates around 4 kbits/s, where the optimal coding mode is selected according to the characteristics of speech frames. Therefore, sensed and subsequently digitized speech signals are divided into a plurality of successive sections regarding time, wherein the sections are termed as speech frames. An increasingly important class of multimodal coding is the hybrid multimodal coding which employs both waveform matching and parametric coding. Waveform coding is often used for transitional segments, such as plosives and voiced onsets/offsets, while parametric coding is used for smoothly evolving speech segments such voiced speech.

With multimodal hybrid coders operating at low bit rates, the interoperability between the time domain and frequency domain coders typically creates a synchronization problem between the input and synthesized speech signals, since no phase information for the sinusoidal components is typically transmitted in low bit rate parametric coders. This problem can be solved by transmitting the necessary phase information for the first fundamental at the end of each frame coded with a parametric coder, in order to match the measured phase information of the input speech, and defining the phases of the other harmonics as multiples of the first harmonic. While this approach suits well in transition between two frames coded with a parametric coder, and in transitions from parametric to waveform frames, problems may be encountered in transitions from waveform to parametric frames. This is because no phase information is transmitted during waveform frames and thus the starting point for the phase interpolation in the parametric frame is undefined. In order to overcome this problem for the waveform-parametric transitions, a method is needed where the initial phase characteristics are provided to the parametric coding ensuring the synchronicity of the input and the synthesized speech signals.

An object of the present invention is to provide a method for determining phase characteristics of a frame coded according to the waveform matching coding for providing this phase characteristics as an initial phase characteristic for parametric coding of a speech frame.

An object of the present invention is to provide a method for detecting synchronization misalignments which allows to take up countermeasures, e.g. re-coding the misaligned frame by providing a correct initial phase characteristic.

Further, an object of the present invention is to provide a communication terminal employing the method for obtaining a phase characteristic, a communication terminal employing the method for detecting synchronization misalignments and a network device employing the method for detecting synchronization misalignments. Additionally, an object of the present invention is to provide a system comprising inter-operating communication terminals and a network device, wherein the network device employs the method for detecting synchronization misalignments.

The objects of the present invention corresponding to the provided method, device and system for providing profile data are attained by the accompanying independent claims. Preferred embodiments thereof are provided by the accompanying dependent claims.

According to an aspect of the invention, a method for providing at least one phase-characterizing parameter for speech processing is provided. Therein, characteristics are obtained from a preceding frame coded according to the waveform matching speech coding. These characteristics are used to derive at least one phase-characterizing parameter. The resulting at least one phase-characterizing parameter is provided as at least one initial parameter for the coding of the frame according to the parametric speech coding. Preferably the frame according to waveform matching coding is immediately preceding said frame according to parametric speech coding. This method according to one embodiment of the present invention may be employed to provide a smooth transition between a frame according to the waveform matching speech coding and a subsequent or immediately succeeding frame according to a parametric speech coding for preventing misalignments due to synchronicity problems. The obtained at least one phase-characterizing parameter may be employed during a speech encoding of the frames or during a speech decoding of the frames.

According to an embodiment of the invention, the obtained characteristics of the frame according to the waveform matching speech coding may comprise a position of a last pulse within said frame according to the waveform matching speech coding. Therefore, positions of at least one pulse may be determined from said frame according to the waveform matching speech coding and the position of a last pulse may be determined thereof.

According to an embodiment of the invention, the at least one pulse is preferably at least one pitch pulse.

According to an embodiment of the invention, the obtained characteristics of the frame according to the waveform matching speech coding may comprise a pulse value. The pulse value may be obtained from a distance between the pulses or the pulse positions, respectively. The pulse value may be a termed as a pitch value or may be termed as a pitch lag, respectively.

According to an embodiment of the invention, the obtained characteristics of the frame according to the waveform matching speech coding may comprise a pulse value. The pulse value may be obtained from an antecedent frame. The pulse value may be a termed as a pitch value or may be termed as a pitch lag, respectively.

According to an embodiment of the invention, the at least one phase-characterizing parameter may depend on the position of the last pulse, a size of the frame according to the waveform matching speech coding and on the pulse. Preferably, at least one phase-characterizing parameter may depend on the position of the last pulse relative to the size of the frame according to the waveform matching speech coding and in relation to the pulse.

According to an embodiment of the invention, the at least one phase-characterizing parameter is at least one phase value. The at least one phase value may be employed as at least one initial phase value. The at least one initial phase value may be employed for the coding of the frame according to the parametric speech coding which may require an at least one initial phase value for interpolating phase values within the frame.

According to an embodiment of the invention, the pulses and the pulse position may be determined by evaluating average energy values, respectively. The average energy values may be determined from the values of the frame according to the waveform matching speech coding. Further the determined average energy values may be evaluated in order to obtain local maximum thereof. The evaluation of the average energy values may be performed within sub-segments of the frame according to the waveform matching speech coding. The sub-segments may be defined by a pitch value. The positions of the obtained local maximum may be equal to the positions of the pulses which may have to be determined and therefore, the positions of the obtained local maximum may represent to the positions of the pulses.

According to an embodiment of the invention, the average energy values may be obtained by determining sliding average values. Sliding averaging takes account of a pre-defined number of values to be averaged adjacent to the value to be averaged. The involved values for determining the sliding average may be comprised in a window which may be slid over the values to be averaged.

According to an aspect of the present invention, a method for detecting a transition misalignment in the transition from a frame according to a waveform matching speech coding to a frame according to a parametric speech coding is provided. Accordingly, information and/or characteristics are obtained from a frame according to said waveform matching speech coding and information/characteristics are obtained from a frame according to said parametric speech coding. The obtained information/characteristics are evaluated in order to detect the transition misalignment.

According to an embodiment of the invention, the information obtained from the frame according to said waveform matching speech coding may comprise a position of a last pulse included therein. Therefore, the positions of at least one pulse included in the frame according to said waveform matching speech coding may be determined. The position of the last pulse is determined from the determined positions. Further, the information obtained from the frame according to said parametric speech coding may comprise a position of a first pulse included therein. Therefore, the positions of at least one pulse included in the frame according to said parametric speech coding may be determined. The position of the first pulse is determined from the determined positions.

According to an embodiment of the invention, the at least one pulse is preferably at least one pitch pulse.

According to an embodiment of the invention, the determined positions of the last pulse and the first pulse may be used to determine a distance between the positions of the last pulse and the first pulse. The evaluation of the obtained information may be a comparing of the determined pulse distance with a pulse value. The pulse value may be obtained from the frame according to the parametric speech coding. The pulse value may be a termed as a pitch value or may be termed as a pitch lag, respectively.

According to an embodiment of the invention, the distances between the identified pulses such as the distance and an adaptive codebook gain may be evaluated. For periodic speech, the distance of the pulses may be very close to the pitch value, and on the other hand high adaptive codebook gain may indicate periodicity. A pitch estimate of the pitch value may be obtained from the distance, respectively.

According to an embodiment of the invention, the difference between the identified pulse positions and the positions defined by using a default phase contour for the waveform frame may be also used to obtain and evaluate pitch estimate of the pitch value, respectively. This default phase contour may be determined based on the phase of the parametric frame and assuming the pitch contour to be fixed or linear. In this case, the pitch value of the parametric frame coded before the analysis frame may be used to define the previous pitch value and hence estimate a valid pitch value. The pulse positions may be derived from the phase contour simply by detecting the indexes where the phase value achieves a value being a multiple of 2π.

According to an embodiment of the invention, the pulses and the pulse position may be determined by evaluating average energy values, respectively. The average energy values may be determined from the values of the frame. Further the determined average energy values may be evaluated in order to obtain local maximum thereof. The evaluation of the average energy values may be performed within sub-segments of the frame. The sub-segments may be defined by a pitch value. The positions of the obtained local maximum may be equal to the positions of the pulses which may have to be determined and therefore, the positions of the obtained local maximum may represent to the positions of the pulses. Advantageously, the average energy values may be obtained by determining by sliding average values.

According to an aspect of the present invention a software tool for providing at least one phase-characterizing parameter for coding a frame according to a parametric speech coding and/or for speech processing is provided. The software tool comprises program portions for carrying out the operations of the aforementioned methods when the software tool is implemented in a computer program and/or executed.

According to an aspect of the present invention a software tool for detecting a transition misalignment from a frame according to a waveform matching speech coding to a frame according to a parametric speech coding and/or for speech processing is provided. The software tool comprises program portions for carrying out the operations of the aforementioned methods when the software tool is implemented in a computer program and/or executed.

According to a further aspect of the present invention a computer program for providing at least one phase-characterizing parameter for coding a frame according to a parametric speech coding and/or for speech processing is provided, comprises program code section for carrying out the above operations of the above methods for providing at least one phase-characterizing parameter for coding a frame according to a parametric speech coding, when said program is run on a computer, a user terminal or a network device.

According to a further aspect of the present invention a computer program for detecting a transition misalignment from a frame according to a waveform matching speech coding to a frame according to a parametric speech coding and/or for speech processing is provided, comprises program code section for carrying out the above operations of the above methods for detecting a transition misalignment from a frame according to a waveform matching speech coding to a frame according to a parametric speech coding, when said program is run on a computer, a user terminal or a network device.

According to a further aspect of the present invention a computer program product for providing at least one phase-characterizing parameter for coding a frame according to a parametric speech coding and/or for speech processing is provided comprising program code section stored on a computer readable medium. The computer program code sections are for carrying out the above mentioned method for providing at least one phase-characterizing parameter for coding a frame according to a parametric speech coding, when said program product is run on a computer, a user terminal or network device.

According to a further aspect of the present invention a computer program product for detecting a transition misalignment from a frame according to a waveform matching speech coding to a frame according to a parametric speech coding and/or for speech processing is provided comprising program code section stored on a computer readable medium. The computer program code sections are for carrying out the above mentioned method for detecting a transition misalignment from a frame according to a waveform matching speech coding to a frame according to a parametric speech coding, when said program product is run on a computer, a user terminal or network device.

According to an aspect of the invention, a communication terminal device offering enhanced quality of transmitted speech data is provided. The terminal comprises a speech encoder for encoding a speech signal supplied thereto. Therefore, the speech encoder includes a parametric speech encoding unit and a waveform matching speech encoding unit. Further, the speech encoder is able to operate the method for providing at least one phase-characterizing parameter for coding a frame according to a parametric speech coding with respect to an embodiment of the present invention. The resulting encoded speech data are transmitted by a communication interface comprised in the terminal.

According to an aspect of the invention, a communication terminal offering enhanced quality of transmitted speech data is provided. The terminal comprise a speech decoder for decoding encoded speech data received by a communication interface comprised in the terminal. Therefore, the speech decoder comprises a parametric speech decoding unit and a waveform matching speech decoding unit. Further, the speech decoder is able to operate the method for detecting a transition misalignment from a frame according to a waveform matching speech coding to a frame according to a parametric speech coding with respect to an embodiment of the present invention.

According to an embodiment of the invention, the terminal may further comprise a speech decoder being additionally able to operate the method for providing at least one phase-characterizing parameter for coding a frame according to a parametric speech coding with respect to an embodiment of the present invention.

According to an aspect of the invention a network device offering enhanced quality of transmitted speech data is provided. The network device comprises a communication interface for receiving encoded speech data and transmitting encoded speech data. Further, the network device comprises an analyzing unit, which is able to operate the method for detecting a transition misalignment from a frame according to a waveform matching speech coding to a frame according to a parametric speech coding with respect to an embodiment of the present invention.

The network device may be also understood as a transceiving unit comprising the analyzing unit for detecting and preferably correcting encoded speech data by receiving, processing and transmitting encoded speech data in accordance with the aforementioned methods.

Additionally, the network device can be a transcoding device or a transcoding units (or a transcoder, respectively). Transcoders allow to convert encoded speech data according to a certain first speech encoding/decoding process into encoded speech data according to a certain second speech encoding/decoding process. Such a transcoder can comprise the aforementioned method offering enhanced quality.

According to an embodiment of the invention, the network device comprise an analyzing unit which is additionally able to operate the method for providing at least one phase-characterizing parameter for coding a frame according to a parametric speech coding with respect to an embodiment of the present invention.

According to an aspect of the invention, a system offering enhanced quality of transmitted speech data is provided. The system comprises a first terminal, a second terminal and an intermediate network device.

The first terminal comprises a speech encoder for encoding speech and a communication interface for transmitting encoded speech data. The second terminal comprises a speech decoder for decoding said encoded speech data and a communication interface for receiving said encoded speech data. The encoded speech data may be transmitted from the first terminal to the second terminal via the intermediate network device. Correspondingly, the intermediate network device is a network device offering enhanced quality of transmitted speech data according to an embodiment of the present invention. The received encoded speech data may be processed to detect misalignments according to the above described method. In case of detecting a misalignment, the intermediate network device may process the encoded speech data such that the misalignment is removed therefrom. The processing may comprise operations of the method at least one phase-characterizing parameter for coding according to an embodiment of the present invention.

The invention will be described in greater detail by description of embodiments with reference to the accompanying drawings, which are all schematic in form of single-line diagrams or block diagrams, respectively, and wherein

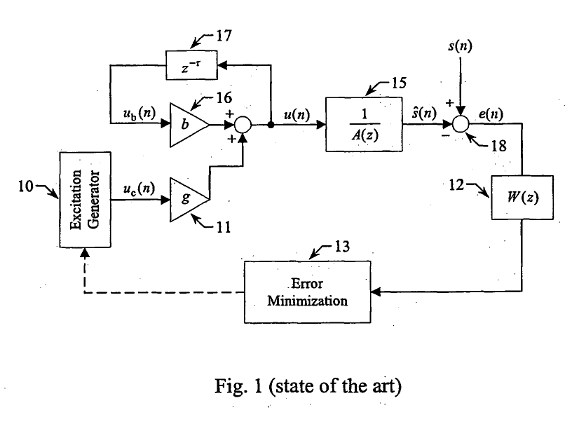

FIG. 1 shows a code excited linear prediction (CELP) encoder of the state of the art,

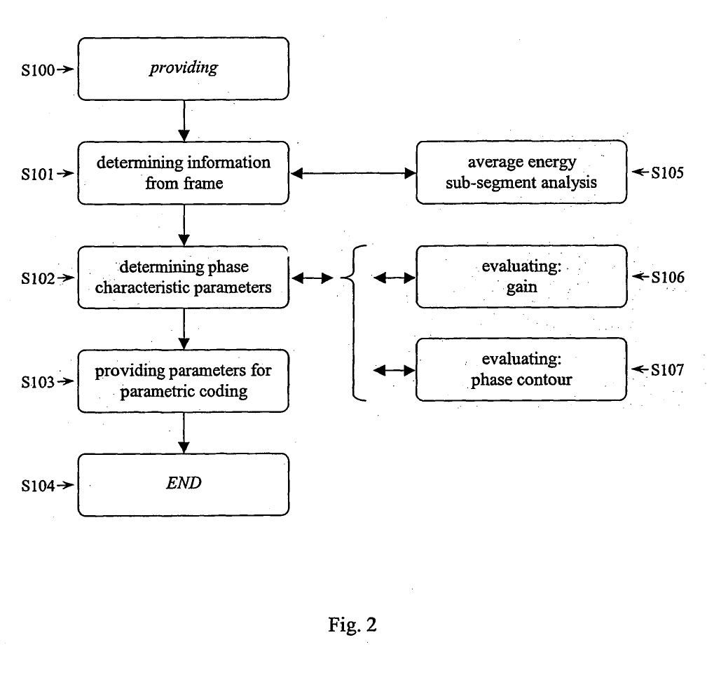

FIG. 2 shows a flow diagram illustrating a sequence of operative steps of the method for providing at least one phase-characterizing parameter according to an embodiment of the present invention,

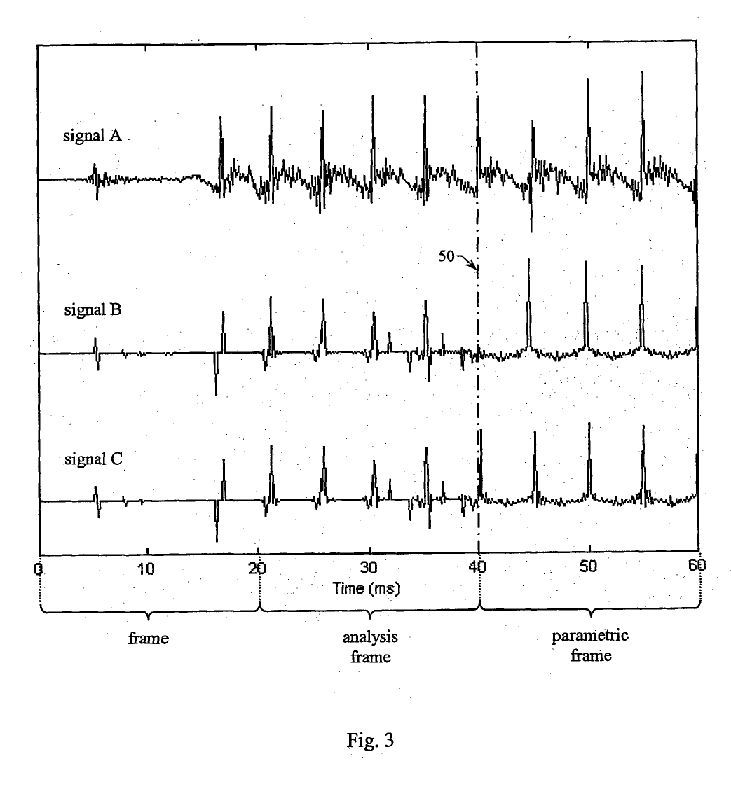

FIG. 3 shows a graph comprising three curves, where a first curve depicts curve an original linear prediction (LP) residual signal, a second curve depicts a reconstructed signal according to the state of the art and a third curve depicts a reconstructed signal in accordance to an embodiment of the method of the invention,

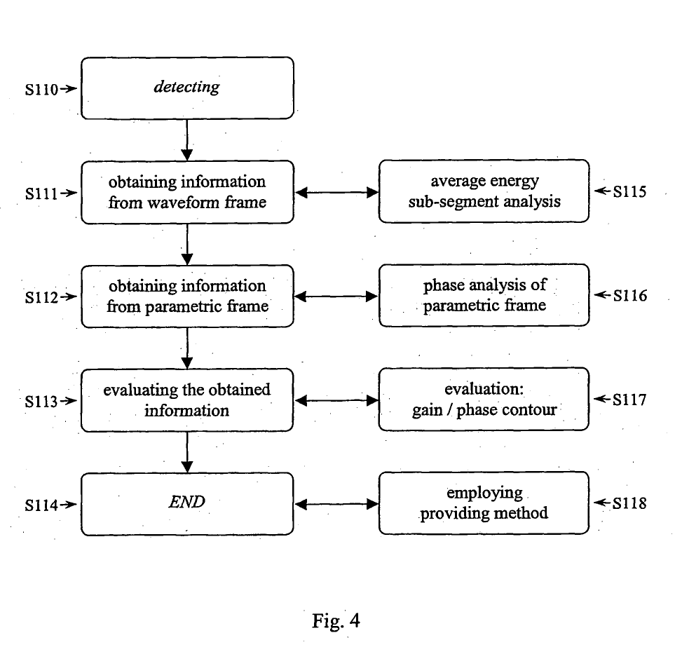

FIG. 4 shows a flow diagram illustrating a sequence of operative steps of the method for detecting a transition misalignment according to an embodiment of the present invention.

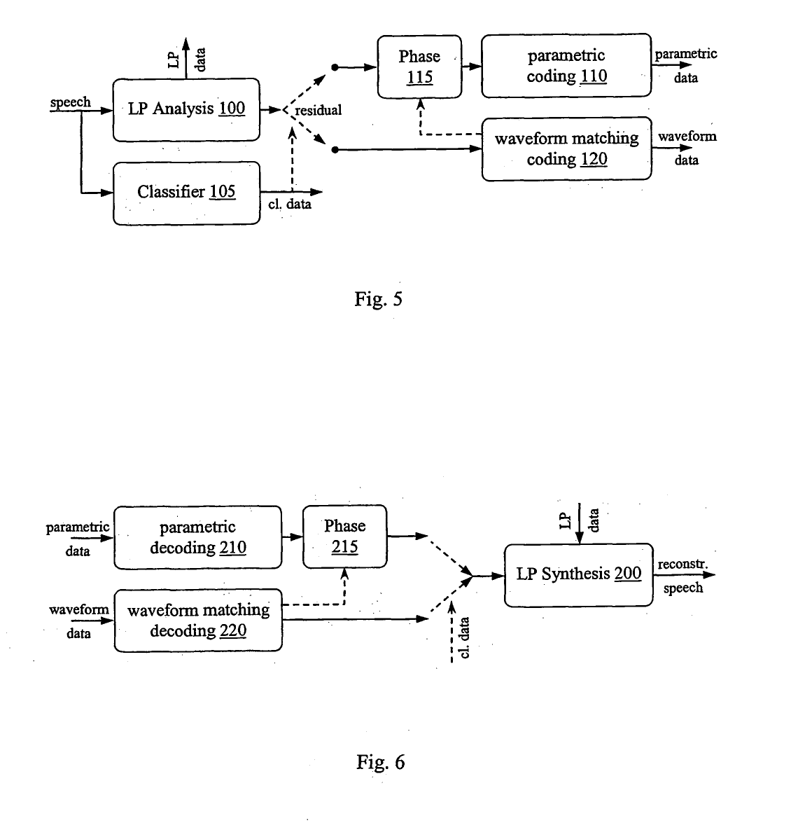

FIG. 5 shows a block diagram illustrating a possible implementation of an encoder able to operate the method for providing at least one phase-characterizing parameter according to an embodiment of the invention,

FIG. 6 shows a block diagram illustrating a possible implementation of an decoder able to operate the method for detecting a transition misalignment according to an embodiment of the invention and

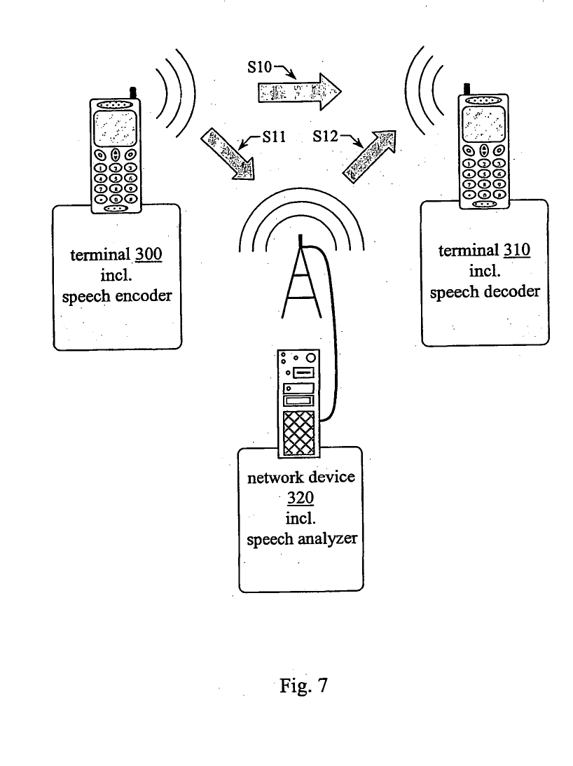

FIG. 7 shows a block diagram illustrating a system comprising to user terminals and an intermediate network device.

The following description relates to the method, to the apparatus and to the system. In the figures corresponding reference numerals denote corresponding features.

The following description will give a short introduction to an exemplary waveform matching coding and an exemplary parametric coding in order to enlighten the problem to be solved by the embodiments of the present invention. The most prominent waveform matching speech coding technique is code excited linear prediction (CELP) coding, while sinusoidal model based coders are the most widely used parametric speech coders. In both speech coding models, the input speech signal is typically processed in frames of fixed length. The frame length is often 10-30 ms, and a look-ahead segment of 5-15 ms of the subsequent frame is also available.

Other suitable waveform codecs that can be used with this invention are, for example, pulse code modulation (PCM) and adaptive PCM (ADPCM) codecs. However, the CELP codec is in practice the best choice for bit rates around 4 kbits/s.

Other suitable parametric codecs that can be used with the invention are, mixed excitation linear prediction (MELP), multi-band excitation (MBE) and waveform interpolation (WI). All of these codecs can in a sense be classified to be relatives or derivatives of the sinusoidal codec. All of the mentioned codecs extract the necessary parameters from the spectrum, and the differences come mainly from the analysis window length and interpolation.

Waveform Matching Coding: Code Excited Linear Prediction (CELP)

FIG. 1 shows a code excited linear prediction (CELP) encoder of the state of the art.

In CELP, a cascade of time variant pitch predictor and linear prediction LP filter is used to model the long-term correlation and short-term correlation in a speech signal. An all-pole LP filter 15 can be defined as

$$H ( z ) = \frac{1}{A ( z )} = \frac{1}{1 + {a}_{1} {z}^{- 1} + {a}_{2} {z}^{- 2} + K + {a}_{{n}_{a}} {z}^{- p}} \qquad ( 1 )$$

where a₁ . . . aₚ are the coefficients of the filter. A pitch predictor of the form

$$\frac{1}{B ( z )} = \frac{1}{1 - {bz}^{- τ}} \qquad ( 2 )$$

models the pitch periodicity of speech. Typically, the gain b 16 is bounded to the interval approximately of 0-1.2, and the pitch period τ, or similarly pitch lag, to the interval approximately of 20-140 samples (assuming a sampling frequency of 8 kHz). The pitch predictor is also referred to as long-term predictor (LTP) filter. In FIG. 1, the LTP filter is represented by the feedback loop consisting of the delay z^{-r} 17 and the gain b 16. The LTP memory can also be seen as a codebook consisting overlapping code-vectors. This codebook is usually referred to as the LTP or adaptive codebook.

An excitation signal u_{c}(n), produced by an excitation generator 10, which typically is a codebook of different candidate vectors representing the noise-like component in speech, is multiplied by a gain g 11 to form an input signal to the filter cascade. The codebook is often called stochastic or fixed codebook. The output of the filter cascade is a synthesized speech signal ŝ(n). In the encoder, an error signal e(n) is computed by subtracting 18 the synthesized speech signal ŝ(n) from the original speech signal s(n), and an error minimizing procedure 13 is employed to choose the best excitation signal provided by the excitation generator 10. Usually a perceptual weighting filter W(z) 12 is applied to the error signal prior to the error minimization procedure. The purpose of such weighting filter 12 is to shape the spectrum of the error signal so that it is less audible. In current CELP coder, a frame is divided into a number of smaller sub-segments for which the adaptive and fixed codebook parameters are then derived.

The encoded parameters of the described CELP structure include LP filter coefficients, pitch and pitch gain, and the fixed codebook index together with its gain. The decoder receives the parameters from the channel, and determines the fixed excitation signal by the received index and gain. The fixed excitation signal is filtered through the LTP-LP filter cascade to produce the synthesized speech signal.

Parametric Coding: Sinusoidal Coding

In sinusoidal coding the speech signal or alternatively the vocal tract excitation signal is represented by a sum of sine waves of arbitrary amplitudes, frequencies and phases:

$$s ( t ) = Re {\sum }_{m = 1}^{L ( t )} {a}_{m} ( t ) \cdot exp ( j [ {\int }_{0}^{t} {ω}_{m} ( t ) ⅆ t + {θ}_{m} ] ) \qquad ( 3 )$$

where, for the m-th sinusoidal component, aₘ and ωₘ(t) represent the amplitude and frequency and θₘ represents a fixed phase offset. To obtain a frame wise representation the parameters are assumed to be constant over the analysis. Thus, the discrete signal s(n) in a given frame is approximated by

$$s ( n ) = {\sum }_{m = 1}^{L} {A}_{m} cos ( n {ω}_{m} + {θ}_{m} ) \qquad ( 4 )$$

where Aₘ and θₘ represent the amplitude and phase of each sine-wave component associated with the frequency track ωₘ, and L is the number of sine-wave components. The sinusoidal model can be employed either to the speech signal itself or to a LP residual signal. At low bit rates it is not amenable to transmit all the derived parameters. Thus, harmonic frequency model and a linear/random phase model are often used to achieve low bit rates without significant degradations in quality. In the harmonic frequency model all the frequencies are assumed to be multiples of the first harmonic frequency defining the speaker's fundamental frequency during voiced speech. In the linear/random phase model, linear phase model where the phase of the l-th sine wave is simply l times the phase of the fundamental frequency is used for the voiced frequencies while random phase is employed for the unvoiced frequencies. In most low bit rate sinusoidal coders, the transmitted parameters include pitch and voicing, amplitude envelope (e.g., LP coefficients and excitation amplitudes), and energy of the speech signal.

To achieve a smoothly evolving synthesized speech signal in sinusoidal coding proper interpolation of the parameters has to be used to avoid discontinuities at the frame boundaries between successive frames. For amplitudes, linear interpolation is widely used while the evolving phase can be interpolated using a cubic or quadratic polynomial between the parameter pairs in the succeeding frames. The interpolated frequency can be computed as a derivative of the phase function. Thus, the resulting model can be defined as

$$\hat{s} ( n ) = {\sum }_{m = 1}^{M} {\hat{A}}_{m} ( n ) cos ( {\hat{θ}}_{m} ( n ) ) \qquad ( 5 )$$

where Âₘ and \hat{θ}ₘ represent the interpolated amplitude and phase contours. As an example, a quadratic polynomial for phase interpolation is defined by
\hat{θ}(n)=ξγn+an² (6)
from which the track subscript m has been omitted for convenience. The frequency is defined as ∂\hat{θ}(n)/∂n=γ+2an and is thus evolving linearly. To match the boundary conditions for the measured parameters for subsequent frames (e.g. the l-th and l+1-th frame) the resulting phase relationship can be derived explicitly. In many sinusoidal coders operating at low bit rates a simpler derivation of the phase relationship is sufficient. In these coders, the phase contour is simply defined as

$$\hat{θ} ( n ) = {θ}^{l} + {ω}^{l} n + ( {ω}^{l + 1} - {ω}^{l} ) \cdot \frac{{n}^{2}}{2 N} \qquad ( 7 )$$

where θ^{l} now is the interpolated phase value at the end of l-th frame. In this approach, no phase characteristic is transmitted to the decoder, which results in synchronization loss at the frame boundary.
Combined Speech Coding

As already mentioned, e.g. hybrid multimodal speech coding employing CELP and sinusoidal based coding is a promising ‘approach for achieving high ’ speech quality at bit rates around 4 kbits/s. With multimodal hybrid coders the interoperability between the waveform matching and parametric coders typically is subjected to a synchronization problem at low bit rates if no initial phase characteristic is transmitted to the parametric coder resulting in asynchrony between the input and synthesized speech signals which may lead to erroneous alignment of subsequent frames. This problem can be solved by transmitting a necessary initial phase characteristic for the first fundamental frequency in order to match the measured phase characteristic. The phases of the other harmonics can be derived from the initial phase characteristic of the first fundamental frequency. While this approach suits well in transition between sinusoidal frames and in transitions from sinusoidal to CELP frames, problems may be countered in transitions from CELP to sinusoidal frames. This is because no phase characteristic is obtained or determined during the coding of CELP frames and thus the initial phase in the sinusoidal frame is undefined.

An initial phase characteristic may be defined e.g. by assuming a constant fundamental frequency for a frame resulting to a phase estimate θ^{l-1} to the beginning of the frame:

$${θ}^{l - 1} = {θ}^{l} - 2 π \frac{N}{τ} \qquad ( 8 )$$

where τ is the pitch value in accordance with the fundamental frequency ω₀=(2πFₛ)/τ where Fₛ is the sampling frequency. While this method using a default phase shift performs quite well in many cases, problems may be encountered especially in cases where a pitch pulse in the original signal is located near the frame boundary.

The following description will present embodiments according to the method for providing at least one phase-characterizing parameter for coding a frame to be coded according to a parametric speech coding with respect to the invention. The presented embodiments are able to overcome misalignment problems like described above. The basic idea of the method for providing at least one phase-characterizing parameter according to the invention will be described in combination with FIG. 2.

FIG. 2 shows a flow diagram illustrating a sequence of operative steps of the method for providing at least one phase-characterizing parameter according to an embodiment of the present invention. In the following description the frame according to a waveform matching speech coding will be denoted as analysis frame whereas the frame according to a parametric speech coding will be denoted as parametric frame.

In an operative step S100, the method for providing at least one phase-characterizing parameter for providing at least one phase-characterizing parameter for coding or for decoding a frame according to a parametric speech coding is started, respectively. The both frames are succeeding frames and the method for providing at least one phase-characterizing parameter may provide particularly a phase characteristic or a phase estimate, respectively, which will be employed as an initial phase characteristic or an initial phase estimate, respectively, for coding the parametric frame. The analysis frame may be coded according to, but is not limited to, the CELP method presented and described above.

In an operative step S101, information are obtained from the analysis frame. The information are characteristic information of the signal within the analysis frame.

The analysis frame contains a plurality of values which may be derived and/or reconstructed from a sensed speech signal. The values are succeeding values in time. In accordance with the sequence of the subsequent values each value has a certain position within the frame. The positions of the values may be indicated by a time value, which may be relative to the frame or by an index, which may be also relative to the frame.

A characteristic information obtained from the analysis frame may be pitch pulses included therein and their positions. The analysis frame may contain at least the one pitch pulse. The last pitch pulse regarding time and its position relative within the frame may be determined.

A further characteristic information obtained from the analysis frame may be a pitch value representing the pitch lag or pitch lag estimate of the pitch pulses, respectively. The pitch lag or the pitch lag estimate may be given by the distance between adjacent succeeding pitch pulses.

In an operative step S102, at least one phase-characterizing parameter is derived from the information obtained for the analysis frame.

Preferably, a phase characteristic or a phase estimate may be derived from the obtained information. Further preferably, a phase characteristic or a phase estimate may be derived from the position of the above determined last pitch pulse, respectively. Additionally, the phase characteristic or the phase estimate may also dependent on the pitch value τ, respectively. This pitch value τ is related to the fundamental frequency ω₀, in accordance with the above introduced relationship ω₀=(2πFₛ)/τ. The pitch value τ may be also obtained from an antecedent frame in time coded according to the parametric speech coding. A mathematical representation of the derivation of the phase characteristic or the phase estimate may be denoted as follows, respectively:

$$θ = \frac{( N - {p}_{last} )}{τ} 2 π \qquad ( 9 )$$

where N represents a size of the analysis frame and pₗₐₛₜ represents a position of the determined last pitch pulse within the frame and θ represents the phase characteristic or the phase estimate to be utilized as an initial phase value for coding the succeeding parametric frame. The size N of the analysis frame may be a period value in accordance with length of the analysis frame in time. Accordingly, the position pₗₐₛₜ is a time value representing the position of the determined last pitch pulse with respect to the length of the analysis frame in time and relative thereto. Further, the size N of the analysis frame may a number representing the number of values included within the analysis frame. Correspondingly, the position pₗₐₛₜ may be an index value of the position in accordance with an increasing indexing of the values within the analysis frame. Additionally, it is assumed, that the phase difference between two succeeding pitch pulses may be 2π, which implies that the fundamental frequency ω₀ of the pitch pulses is assumed to be constant within the frame and consequently also the pitch value τ.

In an operative step S103, the at least one phase characteristic parameter is provided for the coding of the parametric frame. The coding of the parametric frame may require initial values in order to ensure an error-free and an signal loss-free coding. The at least one phase characteristic parameter may be at least one initial parameter therefor.

Preferably, at least one phase characteristic parameter may be a phase characteristic or a phase estimate, respectively. The determined phase characteristic or the phase estimate will be utilized as initial phase value for coding according to a parametric speech coding. The initial phase value may be an initial phase value of the fundamental frequency ω₀. The initial phase values for higher harmonics will be chosen as a multiple of the initial phase value or may be derived therefrom. The parametric frame will be coded according to, but is not limited to, the sinusoidal coding method presented and described above. Herein, the initial phase value may replace the phase estimate obtained according to expression (8).

In an operative step S104, the method for providing at least one phase-characterizing parameter for coding or decoding a frame according to a parametric speech coding is concluded, respectively.

In an operative step S105, the at least one pitch pulse included in the analysis frame is determined by evaluating average energy values, respectively, determined from the values included within the analysis frame. The average energy values may be determined by calculating a sliding average. The sliding average may be determined by sliding a five-point window over the values within the analysis frame and calculating the average energy values E(n) within the window for each value. A pitch pulse may be detected at a position n if the following condition is true:
|E(n−i)|≦|E(n)|, i=−[(τ/2)], −[(τ/₂)]+1, . . . , [(τ/2)] (10)
where τ is the pitch value introduced and described above. Further, it is assumed that the values may be referred by increasing successive indices and correspondingly, the average energy values may be also referred by corresponding indices. The pitch value τ may divide the analysis frame into a plurality of sub-segments each of the length of the pitch value τ. The pitch value can exhibit a different value for each sub-segment. The center of the sub-segments may have assigned an index i=0 such that the indices i of the values within the sub-segments run from i=−[(τ/2)] to i=[(τ/2)]. The index n preferably runs from the beginning of the analysis frame to the end thereof in order to ensure that all pitch pluses are identified by the presented procedure.

Other pitch pulse detection methods based on time-envelope (the energy contour) can also be used with the interpolation. Furthermore, a pattern-recognition approach, where one pulse is used to find matching pulses, can also be applied. Also a method according to the publication “How to track pitch pulses in LP residual ?—joint time-frequency distribution approach”, Z. Ding, I. V. McLoughlin, E. C. Tan, IEEE Pacific Rim Conference on communications, Computer and Signal Processing, pp. 43-46 vol. 1, 2001 can be used.

It should be noted that a look-ahead of [τ/2] values is needed beyond the analysis frame to be able to reliably identify the possible pitch pulses at the end of the analysis frame. Herein the missing values are generated by repeating its values of the analysis frame:
\hat{r}(n)=\hat{r}(n−τ), n>N (11)
where \hat{r}(n) are the values of the analysis frame and N is the frame size.

The evaluation of the average energy values depending on expression (10) results in a sequence of positions related to maximal average energy values within analysis frame and therefore results also in a sequence of positions related to pitch pulses within the analysis frame. The pitch pulse having the highest position index within that frame is the position of the latest pitch pulse used for determining the phase characteristic or the phase value described in the operative step S101 and S102.

Conveniently, the determination of the pulse positions and therefore, the determination of the position of the last pitch pulse bases on the values included within the analysis frame. The values may base on an reconstructed LP residual of the analysis frame such that the derivation of the estimated phase value is done for the reconstructed LP residual in the analysis frame.

Further, the pulse value τ is derived from the positions of the identified pitch pulses. Preferably, an approximate pulse value τ may be derived from the distances of the positions of the identified pitch pulses. Other ways of determining the pulse value may include methods based on correlation or autocorrelation.

In an operative step S106, the correctness of the pitch value is crucial for the determination of the phase characteristic or phase estimate, respectively. To evaluate the correctness of the found pitch pulse/pulses measures such as the distance between them, the found positions and an adaptive codebook gain can be employed. For periodic speech, the distance of the pitch pulses is very close to the pitch value, and on the other hand high adaptive codebook gain indicates periodicity. A pitch estimate of the pitch value τ may be obtained from the distance.

In an operative step S107, the difference between the located pulse positions and the positions defined by using a default phase contour for the analysis frame can be also used to evaluate the correctness. This default phase contour is determined based on the phase value of the parametric frame, and assuming the pitch contour to be fixed as in expression (8) or linear as in expression (7). In this case, the pitch value τ of the parametric frame coded before the analysis frame can be used to define the previous pitch value and hence estimate a valid pitch value τ. The pitch pulse positions can be derived from the phase contour simply by detecting the indexes where the phase value achieves a value being a multiple of 2π.

For meaningful phase estimation in the analysis frame, the signal in that analysis frame should be periodic or contain at least one pitch pulse. In other cases there is no need for phase estimation since the speech signal in the analysis frame is unvoiced and resembles noise. On the other hand, in the analysis frames containing at least one pitch pulse, the positions of these pitch pulses is crucial to achieve a reasonable phase estimate at the end of the analysis frame.

It may be noted that the above described method for providing at least one phase-characterizing parameter for use in a frame according to a parametric speech coding with respect to an embodiment of the present invention, preferably may be employed for use in encoding such a frame according to a parametric speech coding succeeding a frame according to waveform matching speech coding. But conveniently, the above described method with respect to an embodiment of the present invention may also be employed for use in decoding such a frame according to a parametric speech coding succeeding a frame according to waveform matching speech coding. In both cases the obtained at least one phase-characterizing parameter may allow to ensure a smooth transition between the both frames preventing misalignments in the signal synchronicity. The description of the FIG. 2 and FIG. 3 may be advantageously dedicated to the coding of a speech signal which shall not be understood as limiting thereto of the present method according to an embodiment of the present invention.

FIG. 3 shows a graph comprising three curves, where a first curve depicts curve an original linear prediction (LP) residual signal, a second curve depicts a reconstructed signal according to the state of the art and a third curve depicts a reconstructed signal in accordance to an embodiment of the method of the invention.

As demonstrated in FIG. 3 an exemplary hybrid sinusoidal/CELP coder is used employing a frame size of 20 ms. The sinusoidal model was used for the LP residual signal. In the original LP residual shown as curve A (top), a pitch pulse occurs near the frame boundary (marked by a dashed line 50), and is positioned to the sinusoidal/parametric frame. As the reconstruction is done by using the default phase shift, this pitch pulse is positioned beyond the frame boundary and is thus missing from the reconstructed signal shown as curve B (middle). As a result of this discontinuity, clear degradation is present in the output speech quality.

The proposed and above described method is employed on the original LP residual shown as curve A (top). The resulting reconstructed signal shown as curve C (bottom) and basing on the method for providing at least one phase-characterizing parameter for coding a frame to be coded according to a parametric speech coding, the pitch pulse near the frame boundary is preserved by using the estimated phase for the analysis frame.

The FIG. 3 illustrates a missing pitch pulse as a consequence of a pitch pulse being arranged at the beginning of the parametric frame if the default initial phase is used for coding the parametric frame. Similarly, such a pitch pulse may also lead to the occurrence of a double pitch pulse one coded within the analysis frame and one coded within the parametric frame.

The following description will present embodiments according to the method for detecting a transition misalignment from a frame coded according to a waveform matching speech coding to a frame coded according to a parametric speech coding with respect to the invention. The basic idea of the method for providing at least one phase-characterizing parameter according to the invention will be described in combination with FIG. 4.

FIG. 4 shows a flow diagram illustrating a sequence of operative steps of the method for detecting a transition misalignment according to an embodiment of the present invention. In the following description the frame coded according to a waveform matching speech coding will be denoted as waveform frame whereas the frame coded according to a parametric speech coding will be denoted as parametric frame. In order to employ this method for detecting both the waveform frame and the parametric frame may be decoded resulting in reconstructed values, e.g. reconstructed residual signals to be passed on to a LP synthesizing decoder.

In an operative step S10, the method for detecting a transition misalignment from the analysis frame to a parametric frame with respect to an embodiment the invention is started in an operative step S111, information is obtained from the waveform frame. Preferably, the information obtained from the waveform frame may be the position of the last pitch pulse within the waveform frame is determined.

In an operative step S112, information is obtained from the parametric frame. Preferably, the information obtained from the parametric frame may be the position of the first pitch pulse within the parametric frame is determined.

In an operative step S113, the obtained information may be evaluated in order to detect a misalignment of the waveform frame and the succeeding parametric frame.

Preferably, the obtained positions may be evaluated in order to detect a misalignment. Advantageously, a distance between the position of the last pitch pulse within the waveform frame and the first pitch pulse within the parametric frame is determined. This distance is compared with a pitch value π. In accordance with the above described assumption that the phase difference between two successive pitch pulse is 2π, the above determined distance should be substantially approximately equal to the pitch value τ. In case of a distance substantially approximately equal to twice of the pitch value τ it is probable that a pitch pulse is missing from the reconstructed excitation signal or from the parametric frame, respectively, and thereof at the beginning of the parametric frame. In case of a distance substantially significant smaller than the pitch value τ it is probable that duplicated pitch pulses, one at the end of the waveform frame and at the beginning of the parametric frame exist, although only one of these duplicated pitch pulses is a valid pitch pulse. One of the duplicated pitch pulses can be removed in order to correct the pitch pulse sequence. The pitch value τ may be obtained from the parameters provided for reconstructing the excitation signal of the parametric frame.

In an operative step S114, the method for detecting a transition misalignment from the waveform frame to a parametric frame with respect to an embodiment the invention is concluded.

In an operative step S118, in accordance with the results of the method for detecting a transition misalignment it possible to initiate a further process to prevent the detected discontinuity. For example, in case of employing a transmitted default initial phase value which leads to a misalignment of the successive frames, the method for providing at least one phase-characterizing parameter may be employed replacing the default initial phase value with the phase characteristic determined by this method for providing at least one phase-characterizing parameter which may align the successive frame correct.

In an operative step S115 and in an operative step S116, the pitch pluses and their positions may be determined by evaluating average energy values. This procedure of determining of the pitch pluses and their positions is described above in detail with reference to operative step S105 illustrated in FIG. 2. The description of operative step S105 may be employed correspondingly hereto which may be recognized easily by those skilled in the art. Further, the operative step S116 may be a phase analysis of the parametric frame in order to obtain the required phase information.

In an operative step S117, the correctness of the identified pitch pulse/pulses measures such as the distance between them, may be evaluated employing the identified positions and a transmitted adaptive codebook gain for reconstructing. For periodic speech, the distance of the pitch pulses is very close to the transmitted pitch value, and on the other hand high adaptive codebook gain indicates periodicity. A pitch estimate of the pitch value τ may be obtained from the distance.

Further, the difference between the identified pulse positions and the positions defined by using a transmitted default phase contour for the waveform frame can be also used to evaluate the correctness. This transmitted default phase contour is determined based on the phase value of the parametric frame, and assuming the pitch contour to be fixed as in expression (8) or linear as in expression (7). In this case, the pitch value τ of the parametric frame coded before the analysis frame can be used to define the previous pitch value and hence estimate a valid pitch value r. The pitch pulse positions can be derived from the phase contour simply by detecting the indexes where the phase value achieves a value being a multiple of 2π. The operative step S117 is analog to the operative step S107 shown and described with reference to FIG. 2.

Preferably, the above presented method for providing at least one phase-characterizing parameter and for detecting a transition misalignment can be implemented into corresponding speech coders employing waveform matching coding and parametric coding, such as hybrid and/or multimodal coders or the corresponding decoders, respectively. Moreover, embodiments of the both methods may be implemented into an intermediate network device which receives coded speech characteristics of such a coder and forwards the received coded speech information to a corresponding decoder wherein the intermediate network device may analyze the coded speech information in accordance to the method for detecting a transition misalignment according to an embodiment of the invention and may process the coded speech information in case of a positive detecting of a misalignment. The following figures will illustrate corresponding implementations and refer to apparatus and system according to embodiments of the present invention.

FIG. 5 shows a block diagram illustrating a possible implementation of an encoder able to operate the method for providing at least one phase-characterizing parameter according to an embodiment of the invention. The illustrated exemplary coder represents a hybrid multimodal coder comprising several units adapted to operate the corresponding speech encoding procedure The encoder may include a linear predictor (LP) analyzing unit 100, a parametric coding unit 110 and a waveform matching coding unit 120. A preferably sampled speech signal may be supplied to the LP analyzing unit 100 resulting in a residual signal to be passed on to either the a parametric coding unit 110 or the waveform matching coding unit 120. The LP analyzing unit 100 may also provide resulting data of the LP analyzing process to be transmitted to an corresponding decoder.

The further encoding of the residual signal may be based on a classification of the framed speech signal in order to select the coding unit which is able to code the residual signal including less deviations. A classifier 105 may control the forwarding of the residual signal to the following coding units. The evaluation of the classifier 105 may be transmitted to the corresponding decoder.

In case of switching by the classifier 105 from the waveform matching coding unit 120 to the parametric coding unit 110 the method for providing at least one phase-characterizing parameter may be employed additionally. The method for providing at least one phase-characterizing parameter may be implemented into an initial phase estimating unit 115 able to operate the above described method for providing at least one phase-characterizing parameter according ton an embodiment of the invention. Therefore, this initial phase estimating unit 115 may be supplied with information necessary to carry out the method. The necessary information may be supplied by the waveform matching coding unit 120 or/and by the parametric coding unit 110. The operation of the initial phase estimating unit 115 results in providing an initial phase estimate for coding according to the parametric coding by the parametric coding unit 110.

The operation of both the waveform matching coding unit 120 to the parametric coding unit 110 results in data in accordance to the respective coded frames. These data are transmitted to the corresponding decoder.

FIG. 6 shows a block diagram illustrating a possible implementation of an decoder able to operate the method for detecting a transition misalignment according to an embodiment of the invention. The illustrated exemplary decoder represents a hybrid multimodal decoder comprising several units adapted to operate the corresponding speech decoding procedure. The decoder may include a parametric decoding unit 210, a waveform matching decoding unit 220 and a linear predictor (LP) synthesizing unit 200. These units are the analog decoding units to the coding units described with reference to FIG. 5. A preferably coded speech data may be supplied to the encoder. In accordance with the chosen coding method the parametric decoding unit 210 or the waveform matching decoding unit 220 may receive the coded speech data encoded by the respective coding unit of the coder, e.g. the coder shown in FIG. 5. The operation of the parametric decoding unit 210 or the waveform matching decoding unit 220 results in a residual signal which is supplied to the following LP synthesizing unit 200. The operation of the LP synthesizing unit 200 supplied also with the corresponding data obtained by a LP analyzing unit 100 of the corresponding encoder results in a reconstructed speech signal.

In order to detect transition misalignments occurred during the encoding of the speech signal at a switching from a waveform matching coding unit 120 to a parametric coding unit 110, a phase analyzing unit 215 may be implemented. The phase analyzing unit 215 may be adapted to operate the method for detecting a transition misalignment according to an embodiment of the present invention. Therefore the phase analyzing unit 215 evaluates a sequence of pitch pulses included in a resulting decoding frame generated by the waveform matching decoding unit and a succeeding resulting decoding frame generated by the parametric decoding unit 210.

The implemented phase analyzing unit 215 may also be adapted to operate the method for providing at least one phase-characterizing parameter in order to determine a correct initial phase estimate for the parametric decoding unit and process correspondingly the received parametric data.

FIG. 7 shows a block diagram illustrating a system comprising to user terminals and an intermediate network device. The illustrated system includes a terminal 300, a terminal 310 and a network device 320. The terminal 300 includes a speech encoder and the terminal 310 includes a speech decoder. Further, the system may additionally include an intermediate network device 320 comprising a speech analyzing encoder and decoder.

The interoperation of the presented devices will be described in accordance to three different cases.

First Case: Enhanced Encoder

The terminal 300 includes a speech encoder which may be a speech encoder of the kind presented and described in FIG. 5 which is able to operate the method for providing at least one phase-characterizing parameter according to an embodiment of the present invention. The terminal 300 receives a speech signal an codes this speech signal in accordance to the implemented speech encoder. The speech encoder implements the method for providing at least one phase-characterizing parameter according to an embodiment of the present invention such that the obtained speech coding data comprises no misalignments of parametric coded frames in case of preceding waveform matching coded frames. These resulting speech coding data may be transmitted directly S10 and unmodified to the terminal 310 which comprises a corresponding decoder. The decoder of terminal 310 decodes the received speech coding data resulting in a reconstructed speech signal free of any misalignments of the above described kind.

Second Case: Enhanced Decoder

The terminal 310 includes a speech decoder which may be a speech decoder of the kind presented and described in FIG. 6 which is able to operate the method for detecting a transition misalignment according to an embodiment of the present invention. The terminal 300 may include a speech encoder which is not adapted to operate the method for providing at least one phase-characterizing parameter according to an embodiment of the present invention. Correspondingly, a speech signal coded by the encoder of terminal 300 and transmitted directly S10 to the terminal 310 may comprise misalignments which occurred during the encoding of the speech signal at a switching from a waveform matching coding to a parametric coding. These misalignments may be detected by the decoder of terminal 310 which implements the method for detecting a transition misalignment according to an embodiment of the present invention. The detection of the misalignments may lead to corresponding countermeasures of removing these detected misalignments. Such a countermeasure may be given by operating additionally the method for providing at least one phase-characterizing parameter according to an embodiment of the present invention. The decoder of terminal 310 may be able to operate the method for providing at least one phase-characterizing parameter such that a correct initial phase estimate may be supplied to the corresponding parametric decoding sub-unit of the decoder removing the misalignments. In this case the resulting reconstructed speech signal of the decoder is free of any misalignments of the above described kind.

Third Case: Speech Data Analyzer

Both, terminal 300 and terminal 310 may not be able to prevent misalignments of the above described kind. The terminal 300 and the terminal 310 include a speech decoder or a corresponding speech decoder, respectively, not able to operate a method according to an embodiment of the present invention. In order to remove misalignments of the above described kind from the coded speech data the speech signal is encoded by the encoder of terminal 300 transmitted S11 an intermediate network device 320. This intermediate network device 320 processes the coded speech signal and forwards subsequently S12 the coded speech signal to the decoder of terminal 310 which generated a reconstructed speech signal basing on the received coded speech data.

In order to process received coded speech data the intermediate network device 320 may comprise a speech data analyzer. The speech data analyzer may be adapted to operate the method for detecting a transition misalignment according to an embodiment of the present invention. The detection of the misalignments may lead to corresponding countermeasures of removing these detected misalignments. Such a countermeasure may be given by operating additionally the method for providing at least one phase-characterizing parameter according to an embodiment of the present invention. The speech data analyzer may be able to operate the method for providing at least one phase-characterizing parameter such that a correct initial phase estimate may be provided an coded alternatively into the coded speech data removing the initial phase estimate leading to a misalignment.

Additionally, the intermediate network device 320 can be a transcoding device or a transcoding units. Transcoders allow to convert encoded speech data according to a certain first speech encoding/decoding process into encoded speech data according to a certain second speech encoding/decoding process. Such transcoders have to be used in case of transmitting encoded speech data between mobile communication networks which employs different speech encoding/decoding standards. The received encoded speech data is encoded according to this first speech encoding/decoding standard of the first mobile communication network and the resulting speech signal is re-encoded according to this second encoding/decoding standard of the first mobile communication network such that the finally receiving mobile terminal can decode the encoded speech data in order to present a understandable speech signal to a user. It is advantageous to implement the aforementioned method or methods, respectively, offering enhanced quality of transmitted speech data into such a transcoding unit or transcoding device which is of cause a intermediate network device 320 of the aforementioned kind.

The concept of the present invention in broadly described in view of speech encoding and speech decoding. It should be noted that the invention is mostly concerned with the decoder, i.e., detecting the problems at the decoder. However, every encoder needs to include a decoder (to provide the decoded signal for encoding), and therefore the invention is also concerned with the encoder.

This specification contains the description of implementations and embodiments of the present invention with the help of examples. It will be appreciated by a person skilled in the art, that the present invention is not restricted to details of the embodiments presented above, and that the invention can be also implemented in another form without deviating from the characteristics of the invention. The embodiment presented above should be considered as illustrative, but not restricting. Thus, the possibilities of implementing and using the invention are only restricted to the enclosed claims. Consequently, various options of implementing the invention as determined by the claims, including equivalent implementations, also belong to the scope of the invention.

1. A method for providing at least one phase-characterizing parameter for speech processing operable with hybrid speech coders and hybrid speech decoders, comprising:
obtaining characteristics of a preceding frame coded according to a waveform matching speech coding; said preceding frame according to said waveform matching speech coding being immediately preceding in time to a succeeding frame according to a parametric speech coding
characterized by
deriving said at least one phase-characterizing parameter for processing said succeeding frame according to said parametric speech coding from said obtained characteristics;
wherein said at least one phase-characterizing parameter is employable to prevent a misalignment of said frames.

2. The method according to claim 1, wherein said speech processing is a speech encoding operation.

3. The method according to claim 1, wherein said speech processing is a speech decoding operation.

4. The method according to claim 1, wherein said step of obtaining characteristics of said preceding frame according to said waveform matching speech coding comprises:
determining positions of at least one pulse of said preceding frame according to said waveform matching speech coding; and
determining a position of a last pulse of said at least one pulse.

5. The method according to claim 4, wherein said at least one pulse is at least one pitch pulse.

6. The method according to claim 4, wherein said step of obtaining characteristics of said preceding frame according to a waveform matching speech coding comprises:
determining a pulse value from the distances between said at least two pulses.

7. The method according to claim 4, wherein said obtaining characteristics of said preceding frame according to a waveform matching speech coding comprises:
obtaining a pulse value from an antecedent frame.

8. The method according to claim 6, wherein said at least one phase-characterizing parameter is obtained from said position of said last pulse relative to a size of said preceding frame according to said waveform matching speech coding in relation to said pulse value.

9. The method according to claim 1, wherein said at least one phase-characterizing parameter is at least one phase value.

10. The method according to claim 2, wherein said determining of said positions comprises:
determining average energy values from said preceding frame according to said waveform matching speech coding
evaluating said average energy values in order to determine positions of at least one local maximal energy value, and
assigning said positions of said at least one local maximal energy value to said positions of said at least one pulse.

11. The method according to claim 10, wherein said determining said average energy values comprises the step of:
employing a sliding average algorithm in order to determine said average energy values.

12. A method for detecting a transition misalignment in transition from a preceding frame according to a waveform matching speech coding to a succeeding frame according to a parametric speech coding, said preceding frame according to said waveform matching speech coding being immediately preceding in time to said succeeding frame according to said parametric speech coding, comprising:
obtaining characteristics of said preceding frame according to said waveform matching speech coding,
obtaining characteristics of said succeeding frame according to said parametric speech coding, and
evaluating said obtained characteristics in order to detect said transition misalignment.

13. The method according to claim 12, wherein said obtaining characteristics of said preceding frame according to said waveform matching speech coding comprises:
determining positions of at least one pulse from said preceding frame according to said waveform matching speech coding and
determining a position of a last pulse of said at least one pulse,
and wherein said obtaining characteristics of said succeeding frame according to said parametric speech coding comprises:
determining positions of at least one pulse from said succeeding frame according to said parametric speech coding and
determining a position of a first pulse of said at least one pulse,

14. The method according to claim 13, wherein said pulses are pitch pulses.

15. The method according to claim 13 or claim 14, wherein said evaluating said obtained information comprises:
determining a distance of said position of said last pulse and said position of said first pulse and
comparing said distance with a pulse value.

16. The method according to claim 15, wherein said pulse is obtained by the step of:
determining said pulse value from distances of said pulses included in said preceding frame according to said waveform matching speech coding.

17. The method according to claim 15, wherein said pulse is obtained by the step of:
determining said pulse value from a phase contour of an antecedent frame according to said parametric speech coding.

18. The method according to claim 12, wherein said determining of said positions comprises:
determining average energy values from said frame and
evaluating said average energy values in order to determine positions of at least one local maximal energy value and
assigning said positions of said at least one local maximal energy value to said positions of said at least one pulse.

19. A software tool for speech processing, comprising program code portions for carrying out the operations according to claim 1, when said program is implemented in a computer program for executing on a computer, a user terminal or a network device.

20. A computer program for speech processing, comprising program code section for carrying out the operations according to claim 1, when said program is run on a computer, a user terminal or a network device.

21. A computer program product for speech processing, wherein said computer program product comprises program code sections stored on a computer readable medium for carrying out the method according to claim 1, when said program product is run on a computer, a user terminal or network device.

22. A communication terminal device offering enhanced quality of transmitted speech data comprising a speech encoder including a parametric speech encoding unit, a waveform matching speech encoding unit, and a communication interface for communicating speech encoded data via a mobile communication network, wherein said speech encoder is able to operate the method for providing at least one phase-characterizing parameter for coding a succeeding frame according to a parametric speech coding according to claim 1.

23. A communication terminal device offering enhanced quality of transmitted speech data comprising a speech decoder including a parametric speech decoding unit and a waveform matching speech decoding unit and a communication interface for communicating speech encoded data via a mobile communication network, wherein said speech decoder is able to operate the method for detecting a transition misalignment in transition from a preceding frame according to a waveform matching speech coding to a succeeding frame according to a parametric speech coding according to claim 12.

24. The terminal device according to claim 23, said speech decoder being additionally able to operate the method for providing at least one phase-characterizing parameter for coding a succeeding frame according to a parametric speech coding according to claim 1.

25. A network device offering enhanced quality of transmitted speech data comprising a communication interface for receiving encoded speech data and transmitting encoded speech data and an analyzing unit, said analyzing unit being able to operate the method for detecting a transition misalignment from a preceding frame according to a waveform matching speech coding to a succeeding frame according to a parametric speech coding according to claim 12.

26. The network device according to claim 22, said analyzing unit being additionally able to operate the method for providing at least one phase-characterizing parameter for coding a succeeding frame according to a parametric speech coding according to claim 1.

27. A system offering enhanced quality of transmitted speech data comprising:
a first terminal comprising a speech encoder for encoding speech and a communication interface for transmitting encoded speech data,
a first terminal comprising a speech decoder for decoding said encoded speech data and a communication interface for receiving said encoded speech data,
an intermediate network device offering enhanced quality of transmitted speech data according claim 2.
